(19) United States
(12) Patent Application Publication
(10) Pub. No.: US 2024/0342790 A1
(43) Pub. Date: Oct. 17, 2024

(54) SYSTEM AND A METHOD FOR SYNTHESIS OF IRON-BASED NANOPARTICLES

(71) Applicant: KNOWLEDGEPIE PRIVATE LIMITED, JORHAT (IN)

(72) Inventors: MADHULEKHA GOGOI, JORHAT (IN); MANABENDRA BORAH, SIVASAGAR (IN); SANMILAN JYOTI KALITA, JORHAT (IN); LAKSHI SAIKIA, JORHAT (IN); HIMANGSU KOUSIK BORA, JORHAT (IN); RITURAJ KONWAR, JORHAT (IN); ADITYA MAN BORBORAH, JORHAT (IN)

(21) Appl. No.: 18/429,525

(22) Filed: Feb. 1, 2024

(30) Foreign Application Priority Data
Apr. 11, 2023 (IN) 202331026889

(51) Int. Cl. B22F 1/054; B22F 9/06; B22F 9/24; B82Y 30/00; B82Y 40/00

(52) U.S. Cl. CPC B22F 1/054; B22F 9/06; B22F 9/24; B82Y 30/00; B82Y 40/00

(57) ABSTRACT

A method for synthesis of iron-based nanoparticles is disclosed. The method includes mixing, an ascorbic acid solution with a citric acid solution to form a mixture. The mixture includes 20 mL of 0.1 M ascorbic acid solution and 20 mL of 1 M citric acid solution. The method also includes adding, a plurality of iron salts nitrate nonahydrate solution to ascorbic acid and citric acid mixture then stirring, the mixture using a magnetic stirrer and adding 8 ml of 0.005 M of Sodium Hexachloroplatinate Hexahydrate solution to the mixture. Further, the method includes adding a Sodium tetra hydrido borate to the mixture resulting in a black coloured solution along with effervescence and holding, the mixture undisturbed after the effervescence stops to obtain a green coloured solution. Furthermore, the method includes decanting, the green coloured solution, stirring at room temperature and obtaining, a plurality of iron nanoparticles.

### EARLIEST PRIORITY DATE

This application claims priority from a provisional patent application filed in India having patent application Ser. No. 202331026889, filed on 11th day of April 2023, and titled “ULTRASTABLE IRON BASED NANOPARTICLES FOR BIOLOGICAL IMAGING AND THERAPEUTIC APPLICATIONS”.

### FIELD OF INVENTION

Embodiments of a present disclosure relate to field of synthesis of nanoparticles, and more particularly to a system and a method for synthesis of iron-based nanoparticles.

### BACKGROUND

The conventionally used magnetic resonance imaging (MRI) contrast agents are mostly chelates of rare earth element Gadolinium (Gd3+) ion and Manganese (Mn2+) ion producing a positive contrast on T1-weighted images. The magnetic resonance imaging that uses gadolinium-based contrast agents (GBCAs) causes Nephrogenic Systemic Fibrosis (NSF) which is a progressive multiorgan fibrosing condition in patients' exposure. Unfortunately, Nephrogenic Systemic Fibrosis (NSF) has been reported in patients with renal impairment, after multiple times exposure to Gadolinium based CA. Hence, the Gadolinium based CAhas been included with the food and drug administration (FDA) warning label over the packaging and is restricted for use in renal impaired patients. In presently used technology, Gadolinium-based contrast agents (GBCAs) are commonly used in MRI to enhance the visibility of certain tissues and improve diagnostic accuracy. However, GBCAs raise concerns, driving the need for alternative MRI contrast agents. Some of the reasons include safety concerns: GBCAs mostly safe, but rare severe reactions like nephrogenic systemic fibrosis (NSF) in patients with impaired kidney function and gadolinium deposition in various organs, restricted use in certain populations. Due to risks, GBCA use restricted in certain groups like pregnant women, children, severe kidney issues. For imaging of specific diseases, GBCAs are good such as for vessels, tumours, inflammation, but less effective for liver, pancreas, lymph nodes. The Gadolinium-based scarcity prompts alternative agents from more available elements. There is a need for an alternative MRI contrast agents other than GBCAs for improved safety, expanded clinical utility, and enhanced imaging capabilities.

Hence, there is a need for a system and a method for synthesis of iron-based nanoparticles which addresses the aforementioned issues.

### OBJECTIVE OF THE INVENTION

An objective of the present invention is to provide iron-based nanoparticles as magnetic resonance imaging contrast agent.

Another objective of the present invention is to provide a safer option for patients, including those with renal impairment, who may be at higher risk of adverse reactions to traditional contrast agents.

Yet, an objective of the present invention is to provide synthesis of iron-based nanoparticles, wherein the synthesis is green and facile.

Further, an objective of the present invention is to provide an MRI contrast agent having additional therapeutic effect as well.

### BRIEF DESCRIPTION

In accordance with one embodiment of the disclosure, a method for synthesis of iron-based nanoparticles is provided. The method includes mixing, an ascorbic acid solution with a citric acid solution to form a mixture. The mixture includes a20 mL of 0.1 M ascorbic acid solution and 20 mL of 1 M citric acid solution. The method also includes adding, iron salts nitrate nonahydrate solution to ascorbic acid and citric acid mixture, wherein a plurality of iron salts nitrate nonahydrate solution comprises 8 mL of 0.033 M iron salts. Further, the method includes stirring, the mixture using a magnetic stirrer at room temperature, wherein the stirring is performed for a predetermined time period. Furthermore, the method includes adding, 8 ml of 0.005 M of Sodium Hexachloroplatinate Hexahydrate solution in dropwise manner to the mixture. Furthermore, the method includes adding, a definite amount of Sodium boro hydrideto the mixture resulting in a black coloured solution along with effervescence. Furthermore, the method includes holding, the mixture undisturbed for a predefined time after the effervescence stops to obtain a green coloured solution. Furthermore, the method includes decanting, the green coloured solution from a very thin black layer formed at the bottom of a container and the iron nanoparticles are obtained by rota evaporation and vacuum dried, wherein the green solution is stirred at room temperature for a pre-determined time period.

In accordance with another embodiment, a system for synthesis of iron-based nanoparticles is provided. The system includes a mixing unit and a storing unit. The mixing unit is adapted to mix ascorbic acid solution with a citric acid solution in a container to form a mixture. The mixture includes 20 mL of 0.1 M ascorbic acid solution and 20 mL of 1 M citric acid solution. The mixture unit is also adapted to add a plurality of Iron salts nitrate nonahydrate solution to ascorbic acid and citric acid mixture, wherein a plurality of Iron salts nitrate nonahydrate solution comprises 8 mL of 0.033 M Iron salts. Further, the mixture unit is adapted to stir the mixture using a magnetic stirring process at room temperature, wherein the stirring is performed for 1.25 hours. Furthermore, the mixture is adapted to add a Sodium Hexachloroplatinate Hexahydrate solution in dropwise manner to the prepared mixture. Furthermore, the mixture is adapted to add a Sodium tetra hydrido borate to the mixture resulting in a black coloured solution along with effervescence. Furthermore, the mixture is adapted to keep the mixture undisturbed for a predefined time after the effervescence stops to obtain a green coloured solution. The storing unit is operatively connected with the mixing unit. The storing unit is adapted to decant the green coloured solution from a very thin black layer formed at the bottom of the container, wherein the green solution is stirred at room temperature for twenty-four hours. The storing unit is also adapted to obtain a plurality of iron nanoparticles by rota evaporation and vacuum dry process.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a flow chart representing steps involved in a method for synthesis of iron-based nanoparticles in accordance with an embodiment of the present disclosure;

FIG. 2 is a block diagram representing a system for synthesis of iron-based nanoparticles in accordance with an embodiment of the present disclosure;

FIG. 3 is a schematic representation of an exemplary microscopic view of cytotoxicity study of iron nanoparticles in Human Embryonic Kidney cell line of FIG. 2 in accordance with an embodiment of the present disclosure;

FIG. 4 is a schematic representation of an exemplary embodiment of magnetic resonance images of a Sprague-Dawley rat before and after administration of the synthesized iron-based nanoparticles as magnetic resonance imaging contrast agent of FIG. 2 in accordance with an embodiment of the present disclosure; and

FIG. 5 is a schematic representation of T1-weighted ex vivo magnetic resonance images of iron-platinum (FePt) nanoparticles at different concentrations in water of FIG. 2 in accordance with an embodiment of the present disclosure.

Further, those skilled in the art will appreciate that elements in the figures are illustrated for simplicity and may not have necessarily been drawn to scale. Furthermore, in terms of the construction of the system, one or more components of the system may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a method for synthesis of iron-based nanoparticles is provided. The method includes mixing, an ascorbic acid solution with a citric acid solution to form a mixture. The mixture includes a 20 mL of 0.1 M ascorbic acid solution and 20 mL of 1 M citric acid solution. The method also includes adding, a plurality of iron salts nitrate nonahydrate solution to ascorbic acid and citric acid mixture, wherein a plurality of iron salts nitrate nonahydrate solution comprises 8 mL of 0.033 M iron salts. Further, the method includes stirring, the mixture using a magnetic stirrer at room temperature, wherein the stirring is performed for a predetermined time period. Furthermore, the method includes adding, 8 ml of 0.005 M of Sodium Hexachloroplatinate Hexahydrate solution in dropwise manner to the mixture. Furthermore, the method includes adding, a Sodium tetra hydrido borate to the mixture resulting in a very thin black coloured solution along with effervescence. Furthermore, the method includes holding, the mixture undisturbed for a predefined time after the effervescence stops to obtain a green coloured solution. Furthermore, the method includes decanting, the green coloured solution from a very thin black layer formed at the bottom of a container and the iron nanoparticles are obtained by rota evaporation and vacuum dried, wherein the green solution is stirred at room temperature for a pre-determined time period.

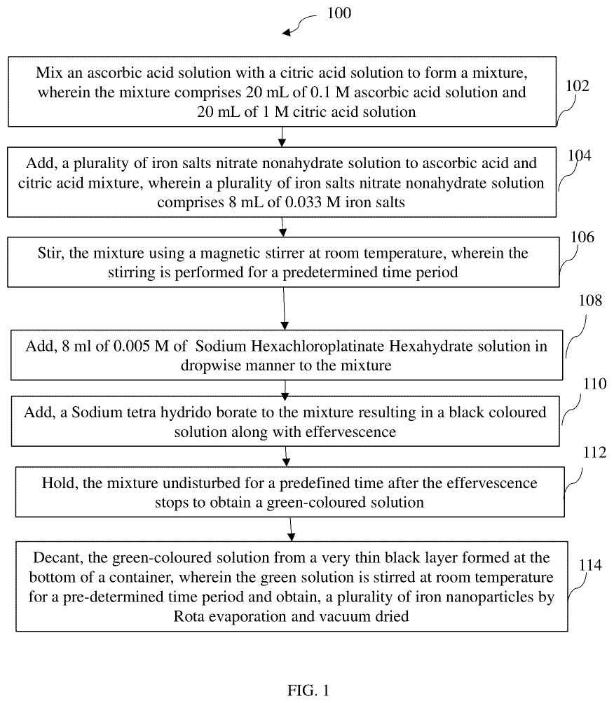

FIG. 1 is a flowchart representing of a method 100 for synthesis of iron-based nanoparticles. The method includes mixing, an ascorbic acid solution with a citric acid solution to form a mixture. The mixture includes 20 mL of 0.1 M ascorbic acid solution. The mixture also includes 20 mL of 1 M citric acid solution in step 102.

The method 100 also includes adding, a plurality of iron salts nitrate nonahydrate solution to the prepared ascorbic acid and citric acid mixture. The plurality of iron salts nitrate nonahydrate solution includes 8 mL of 0.033 M iron salts such as Iron (III) nitrate nonahydrate (Fe (NO3) 3.9H2O) (104).

Further, the method 100 includes stirring, the mixture using a magnetic stirrer at room temperature, wherein the stirring is performed for a predetermined time period in step 106. In one embodiment, the predetermined period is 1.25 hrs.

Furthermore, the method 100 includes adding, 8 ml of 0.005 M of Sodium Hexachloroplatinate Hexahydrate (Na2PtCl66H2O) solution in dropwise manner to the mixture in step 108. In one embodiment, the dropwise method allows continuous mixing of the Sodium Hexachloroplatinate Hexahydrate solution.

Furthermore, the method 100 includes adding, a Sodium tetra hydrido borate (NaBH4) to the mixture resulting in a black coloured includes along with effervescence in step 110. In one embodiment, the method includes adding, 8 mL of 0.005 M solution of Sodium Hexachloroplatinate Hexahydrate (Na2PtCl66H2O) to the mixture.

Furthermore, the method 100 includes holding, the mixture undisturbed for a predefined time after the effervescence stops to obtain a green coloured solution in step 112. In one embodiment, the pre-determined time period is 24 hrs.

Furthermore, the method 100 includes decanting, the green coloured solution from a very thin black layer formed at the bottom of a container and the iron nanoparticles are obtained by rota evaporation and vacuum dried. The green solution is stirred at room temperature for a pre-determined time period in step 114. In one embodiment, the pre-determined time period is 24 hrs.

In another embodiment, the method includes adding, 1.0192 gm of Sodium tetra hydrido borate to the mixture (NaBH4).

It will be appreciated to those skilled in the art that, the plurality of iron nanoparticles may be used in several applications, not limited to, biological imaging and therapeutic applications.

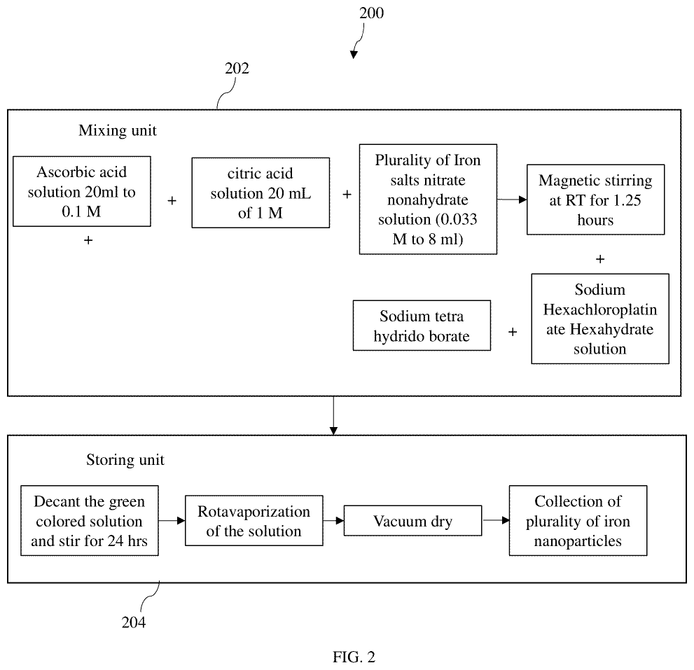

FIG. 2 is a schematic representation of a system 200 for synthesis of iron-based nanoparticles. The system 200 includes a mixing unit 202 and a storing unit 204.

The mixing unit 202 is adapted to mix ascorbic acid solution with a citric acid solution in a container to form a mixture. The mixture includes 20 mL of 0.1 M ascorbic acid solution. The method also includes 20 mL of 1 M citric acid solution. The mixing unit 202 is also adapted to add a plurality of Iron salts nitrate nonahydrate solution to ascorbic acid and citric acid mixture. The plurality of Iron salts nitrate nonahydrate solution comprises 8 mL of 0.033 M Iron salts. Further, the mixing unit 202 is adapted to stir the mixture using a magnetic stirring process at room temperature. Furthermore, the mixing unit 202 is adapted to add a Sodium Hexachloroplatinate Hexahydrate solution (Na2PtCl66H2O) in dropwise manner to the prepared mixture.

Furthermore, the mixing unit 202 is adapted to add a Sodium tetra hydrido borate to the mixture resulting in a black coloured solution along with effervescence. Furthermore, the mixing unit 202 is adapted to keep the mixture undisturbed for a predefined time after the effervescence stops to obtain a green coloured solution.

In one embodiment, wherein mixture comprises 8 mL of 0.005 M solution of Sodium Hexachloroplatinate Hexahydrate. In another embodiment, the mixture includes 1.0192 gm of Sodium tetra hydrido borate.

The storing unit 204 is operatively connected with the mixing unit 202. The storing unit 204 is adapted to decant the green coloured solution from a very thin black layer formed at the bottom of the container. The green solution is stirred at room temperature for twenty-four hours. The storing unit 204 is also adapted to obtain a plurality of iron nanoparticles by rota evaporation and vacuum dry process.

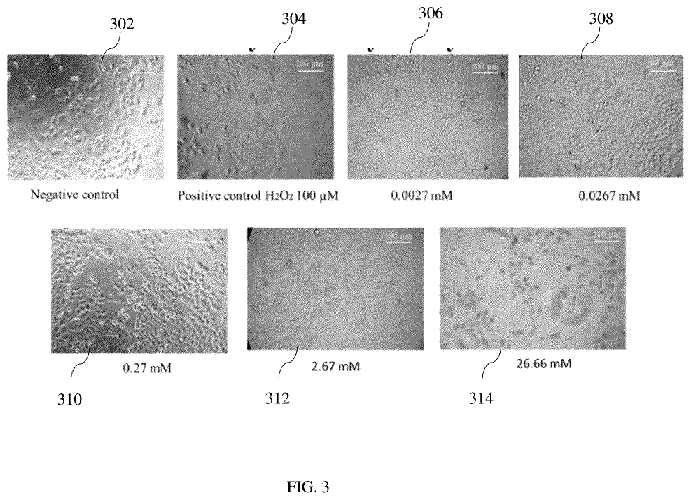

FIG. 3 is a schematic representation of an exemplary microscopic view of cytotoxicity study of iron nanoparticles in Human Embryonic Kidney cell line of FIG. 2 in accordance with an embodiment of the present disclosure. In one embodiment the cytotoxicity study of the iron nanoparticles is carried out in human embryonic kidney (HeK) cell line which shows that the nanoparticles are not toxic. In another embodiment, the cytotoxicity is carried out for 14 days acute toxicity study in a rat model. Also, the haematology, serum biochemistry, necropsy and distribution analysis are corroborated to the safety profile of the developed nano particles. The therapeutic effect of the nanoparticles is observed in LA7 cancer cell line. In one embodiment, the FePt NPs may not show significant toxicity besides the concentration 26.66 mM and the rest of the other concentrations have shown cell viability at different concentrations ranging from-0.0027 mM, 0.0267, 0.27 mM, 2.67 mM with respect to Fe respectively. In one embodiment, the maximum resolution is 20× and minimum is 10×.

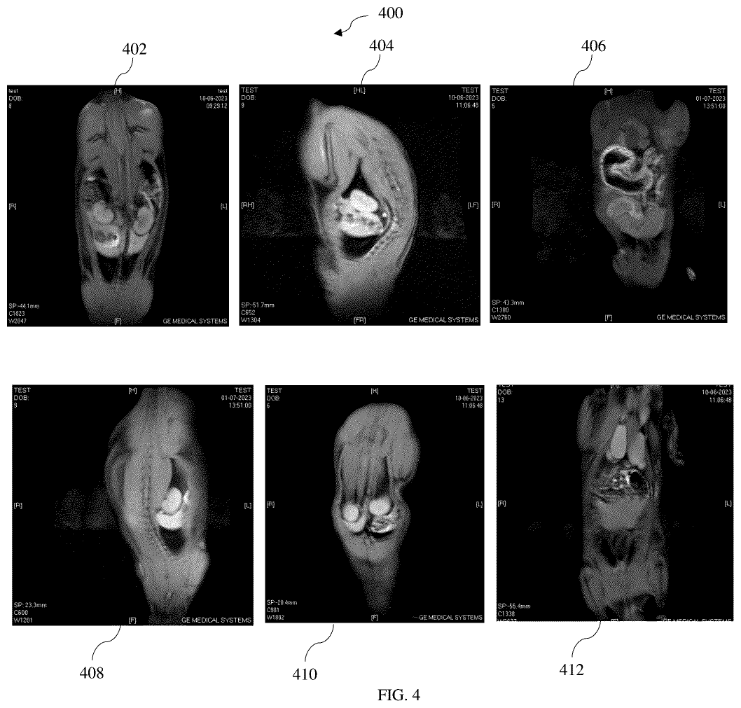

FIG. 4 is a schematic representation 400 of an exemplary embodiment of magnetic resonance images of a Sprague-Dawley rat before and after administration of the synthesized iron-based nanoparticles as magnetic resonance imaging contrast agent of FIG. 2 in accordance with an embodiment of the present disclosure. It must be noted that with the increase in concentration of nanoparticle, the contrast property enhanced significantly. The MR image 402 of the animal before inserting contrast agent is shown. The two MR images 404 and 406 of animal five minutes after inserting the contrast agent are shown. Further, three consecutive MR images are observed where one is after 20 minutes 408 of inserting the contrast agent, and other two 410 and 412 after two hours of inserting the contrast agent are shown.

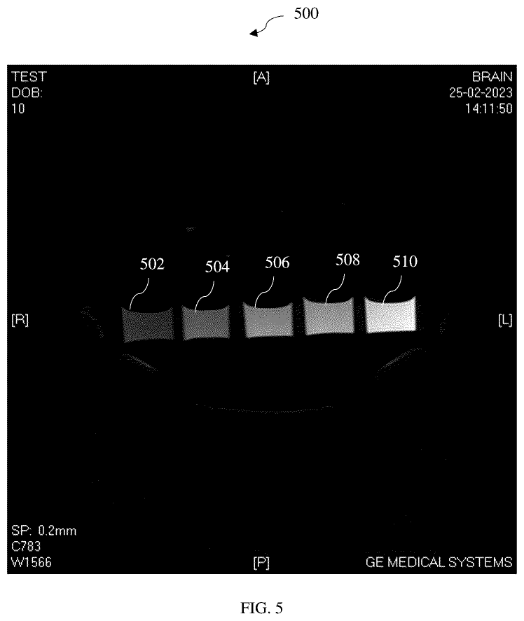

FIG. 5 is a schematic representation 500 of T1-weighted ex vivo magnetic resonance images of iron-platinum (FePt) nanoparticles at different concentrations in water of FIG. 2 in accordance with an embodiment of the present disclosure. In one embodiment, the T1-weighted ex vivo magnetic resonance images (MRI) of FePt nanoparticles at different concentrations in water without any anomaly and brightening property used. The MRI image before adding FePt nanoparticle in water 502 is shown. The MRI image by adding 1 mg/ml of FePt nanoparticles 504 is shown which is brighter than 502. The MRI image 506 shows more brighter MRI image after adding 5 mg/ml FePt nanoparticles in water. The MRI image 508 illustrates MRI image after adding 10 mg/ml of FePt nanoparticles in the water. Subsequently, 510 shows brightness of the MRI image after adding 15 ml/mg of FePt nanoparticle concentration in the water. In one embodiment, the magnet strength 1.5 T, TR (ms): 2534, TE (ms): 8.504, FOV: 21×16, matrix: 320×224, slice (mm): 3, scan mode: T1, FS+C.

Various embodiments of the present disclosure provide a method for synthesis of iron-based nanoparticles, as the iron-based nanoparticles act as magnetic resonance imaging contrast agent. The method disclosed in the present disclosure provides a safer option for patients, including those with renal impairment, who may be at higher risk of adverse reactions to traditional contrast agents by adding the ascorbic acid solution with the citric acid solution to form a mixture. The method provides green synthesis of iron nanoparticles as only water is used as solvent and no other organic solvents are used. Also, the method is facile as stirring of the solution is performed at room temperature no thermal treatment to the solution is performed.

Further, the method disclosed in the present disclosure facilitates even mixing of the Sodium Hexachloroplatinate Hexahydrate solution in the iron platinum nanoparticles as the adding process uses a dropwise approach.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A method for synthesis of iron-based nanoparticles comprising:
mixing, an ascorbic acid solution with a citric acid solution to form a mixture, wherein the mixture comprises:
20 mL of 0.1 M ascorbic acid solution; and
20 mL of 1 M citric acid solution;
adding, a plurality of iron salts nitrate nonahydrate solution to ascorbic acid and citric acid mixture, wherein the plurality of iron salts nitrate nonahydrate solution comprises 8 mL of 0.033 M iron salts;
stirring, the mixture using a magnetic stirrer at room temperature, wherein the stirring is performed for a predetermined time period;
adding, 8 ml of 0.005 M of Sodium Hexachloroplatinate Hexahydrate solution in dropwise manner to the mixture;
adding, a Sodium tetra hydrido borate to the mixture resulting in a black coloured solution along with effervescence;
holding, the mixture undisturbed for a predefined time after the effervescence stops to obtain a green coloured solution; and
decanting, the green coloured solution from a thin black layer formed at the bottom of a container and the iron nanoparticles are obtained by rota evaporation and vacuum dried, wherein the green solution is stirred at room temperature for a pre-determined time period.

2. The method as claimed in claim 1, wherein mixture comprises 8 mL of 0.005 M solution of Sodium Hexachloroplatinate Hexahydrate.

3. The method as claimed in claim 1, wherein the mixture comprises 1.0192 gm of Sodium tetra hydrido borate.

4. A system for synthesis of iron-based nanoparticles comprising:
a mixing unit adapted to:
mix ascorbic acid solution with a citric acid solution in a container to form a mixture, wherein the mixture comprises:
20 mL of 0.1 M ascorbic acid solution; and
20 mL of 1 M citric acid solution;
adds a plurality of Iron salts nitrate nonahydrate solution to ascorbic acid and citric acid mixture, wherein a plurality of Iron salts nitrate nonahydrate solution comprises 8 mL of 0.033 M Iron salts;
stir the mixture using a magnetic stirring process at room temperature, wherein the stirring is performed for 1.25 hours;
add 8 ml of 0.005 M of Sodium Hexachloroplatinate Hexahydrate solution in dropwise manner to the prepared mixture; and
add a Sodium tetra hydrido borate to the mixture resulting in a black coloured solution along with effervescence; and
keep the mixture undisturbed for a predefined time after the effervescence stops to obtain a green coloured solution;
a storing unit operatively connected with the mixing unit, wherein the storing unit is adapted to:
decant the green coloured solution from a thin black layer formed at the bottom of the container, wherein the green solution is stirred at room temperature for twenty-four hours; and
obtain a plurality of iron nanoparticles by rota evaporation and vacuum dry process.

5. The system as claimed in claim 4, wherein the iron-based nanoparticles act as magnetic resonance imaging contrast agent.
